(19) United States
(12) Patent Application Publication
(10) Pub. No.: US 2026/0268135 A1
(43) Pub. Date: Sep. 10, 2026

(54) METHODS AND SYSTEMS FOR VERIFYING MODELS AGAINST CONVOLUTIONAL PERTURBATIONS VIA PARAMETERIZED KERNELS

(71) Applicant: Safe Intelligence Limited, Haringey, London (GB)

(72) Inventors: Benedikt Brückner, London (GB); Alessio Lomuscio, London (GB)

(21) Appl. No.: 19/550,924

(22) Filed: Feb. 26, 2026

Related U.S. Application Data
(60) Provisional application No. 63/764,547, filed on Feb. 27, 2025.

(51) Int. Cl. G06N 3/08

(52) U.S. Cl. CPC G06N 3/08

(57) ABSTRACT

The present disclosure is directed to methods and systems that provide for efficient verification of neural networks against convolutional perturbations such as blurring and sharpening. Perturbation kernels are constructed based on user input, and parameterized versions of the perturbation kernels are derived as one or more matrices. Results of convolved input data for the user model are precomputed with the matrix (ices), and a robustness verification analysis of the user model is performed with prepended threshold layers. A determination is made regarding robustness according to a perturbation specification, and based upon that determination, an indication of robustness is provided to the user and/or counterexamples can be extracted and returned to modify the user model such that the model can be modified based on the counterexamples. The data analyzed by the methods and systems can include images, and thus kernels can include camera shake, box blur, and sharpen kernels.

### CROSS REFERENCE TO RELATED APPLICATION(S)

The present disclosure claims priority to and the benefit of U.S. Provisional Patent Application No. 63/764,547, entitled “METHODS AND SYSTEMS FOR VERIFYING MODELS AGAINST CONVOLUTIONAL PERTURBATIONS VIA PARAMETERIZED KERNELS,” filed on Feb. 27, 2025, the content of which is incorporated by reference herein in its entirety.

### TECHNICAL FIELD

This disclosure generally describes methods and systems for verifying the accuracy and reliability of models, such as neural networks processing inputs of various kinds (e.g., images), and more particularly relates to a pipeline for verifying models against convolutional perturbations of the inputs, such as blurring and/or sharpening.

### BACKGROUND

As models such as neural networks are increasingly deployed in safety-critical domains, such as autonomous vehicles, aviation, and/or robotics, concerns about their reliability are rising. Networks can be vulnerable to adversarial attacks (e.g., perturbations that are often imperceptible, but change the output of a model for a given instance). Such adversarial attacks can also exist in the physical world and pose a threat to algorithms deployed in practical applications. Neural network verification can be used to address these issues by formally establishing that for a given input, a network is robust with respect to a set of specified perturbations.

Verification algorithms can be divided into complete and incomplete approaches. Given enough time, complete methods can provide a definitive answer to the verification problem. In contrast, incomplete methods may not be able to answer the verification problem, returning an undecided result. Complete approaches often employ an exact encoding of the network at hand. They can rely on techniques such as Mixed Integer Linear Programming (MILP). Incomplete verifiers can employ methods such as Semidefinite Programming and/or bound propagation. Said techniques can overapproximate a true behavior of a neural network, and they can be made complete by combining them with a Branch and Bound (BaB) strategy, which can refine approximations that are used. Stronger verifiers either may employ tighter relaxations such as SDP-based ones or linear constraints that reason over multiple neurons simultaneously. State-of-the-art (SoA) verifiers may achieve low runtimes through exploiting GPU-enabled parallelism.

Early approaches can establish local robustness against norm-based perturbations, often referred to as white noise. Robustness to photometric perturbations, such as brightness, contrast, hue, and/or saturation changes, as well as more expressive bias field perturbations, can be verified by prepending suitable layers to a neural network. Verifiers may also be extended to handle complex geometric perturbations, such as rotations, translations, shearing, and/or scaling, although verification against such perturbations can require further modifications and/or extensions. Other approaches can focus on verification of robustness to occlusions and/or semantically rich perturbations in a latent space of generative models.

### SUMMARY

The disclosure generally describes technology for a robustness verification pipeline that can be used to assess the resilience of models, such as neural networks, with respect to perturbations, such as blur (e.g., blur from a camera movement). More specifically, the disclosed technology provides for efficient verification of neural networks against convolutional perturbations, including but not limited to blurring and/or sharpening. To define input perturbations, camera shake, box blur, and/or sharpen kernels may be used. Said kernels can be linearly parameterized in a way that allows for a variation of perturbation strength while preserving desired kernel properties. To facilitate their use in neural network verification, an efficient way of convolving a given input with the parameterized kernels can be implemented. A result of this convolution can be used to encode the perturbation in a verification setting by prepending a linear layer to a given network. This can result in tight bounds and a high effectiveness in resulting verification processes. Additional precision can be applied by employing input splitting as a branching strategy. Accordingly, the disclosed technology can verify robustness on a number of benchmarks where a baseline may be unable to provide safety certificates.

Verification against camera shake and related convolutional perturbations can be important at least because these phenomena are likely to appear in the real world. Existing systems can provide verification against some perturbations by using an algorithm that yields counterexamples, which can be difficult to interpret, and can produce loose bounds, thereby preventing robustness verification of larger networks and/or networks with large input sizes. The disclosed technology, on the other hand, utilizes parameterized kernels that can be easy to implement and allow for verification of network robustness to a number of semantically interesting perturbations. The disclosed technology can be used to verify properties for models, such as neural networks, that may not be solved by using the existing systems. Accordingly, the disclosed technology can be used to identify weaknesses of models to specific types of convolutional perturbations that might otherwise remain hidden, including but not limited to motion blurring along axes of specific angles. The disclosed technology may be also expanded to apply to various other convolutional perturbations to provide robustness checks for deployed systems, including but not limited to artificial intelligence (AI) systems.

The systems and techniques described herein may provide one or more of the following advantages. For example, the disclosed technology provides improved techniques for robustifying models against fragilities of said models. Existing verification systems provide verification for only general convolutional perturbations using coarse approximations of their behavior. As a result, the existing systems are not scalable to models of practical interest and are unable to address specific types of perturbations, including but not limited to camera shake, movement, and/or blur. Moreover, the existing systems do not produce informative counterexamples that can be used for retraining and/or modifying the models. The models have been found to exhibit a significant degradation of performance in the presence of motion blur, as one illustrative example. The disclosed technology provides solutions for improving robustness of the models in the presence of motion blur, and other perturbations, for instance by applying a convolution operation using suitable kernels to a given input image. Using different kernels, convolution operations can similarly be used to implement other image transformations, which can include but are not limited to box blur and/or sharpening. At least because many semantically interesting and realistic perturbations can be modelled by using convolutions, being able to verify robustness to perturbations in a kernel space, as provided by the disclosed technology, is advantageous over the existing systems. The existing systems may encode contrast, haze, and/or blur perturbations, but only verification for haze while resorting to empirical testing for contrast and blur. Other existing systems may provide a general method, which, if successful, can certify robustness of a model to possible perturbations represented by a kernel of a given size. However, such generality comes at a cost in the existing systems. For example, it can lead to loose bounds and a high dimensionality of the perturbation, which makes verification difficult, even more so for large models/networks. The universality also implies that counterexamples, which are misclassified by the model, may be difficult to interpret.

The disclosed technology cures the deficiencies of the existing systems by providing a robustness verification pipeline against convolutional perturbations. The disclosed technology provides technical improvements to existing verification systems and pipelines by providing an efficient and symbolic encoding of perturbations. The disclosed technology can show how an arbitrary but constant input efficiently is convolved with a linearly parameterized kernel using convolutional operations. The disclosed technology also provides technical solutions in the form of parameterized kernels for motion blur perturbations with various blurring angles, box blur, sharpen, etc. Using the disclosed technology can result in significantly easier and more accurate verification due, at least in part, to tighter bounds and/or lower dimensionality of perturbation.

Additionally, the disclosed technology may not be reasonably performed in the human mind. The specific operations that are performed in the described verification pipeline and generation of recommendations for improving models based on execution of the pipeline produces reliable and accurate outputs, all of which may not be reasonably possible in the human mind.

In summary, some of the main advantages of the present disclosures include scalability, the ability to verify robustness to specific perturbations of interest, providing more useful and/or interpretable counterexamples, and ease of implementation.

The details of one or more implementations are set forth in the accompanying drawings and the description below. Other features and advantages will be apparent from the description and drawings, and from the claims.

### BRIEF DESCRIPTION OF THE DRAWINGS

The disclosure will be more fully understood from the following description taken in conjunction with the accompanying drawings, in which:

FIG. 1 is a conceptual diagram of a system for verifying a model, such as a neural network, for robustness against convolutional perturbations in a verification pipeline;

FIG. 2 is a flowchart of a process for verifying a model against convolutional perturbations using parameterized kernels;

FIG. 3 illustrates an example of a convolution of an input I with a kernel K;

FIG. 4 illustrates example visualizations of kernels used in the disclosed verification pipeline;

FIG. 5 is an example table of results from using the disclosed verification pipeline;

FIG. 6 is another example table of results from using the disclosed verification pipeline;

FIG. 7 is an example table of an ablation study using the disclosed verification pipeline;

FIG. 8 is an example table of results from using the disclosed technology;

FIG. 9A is another example table of results from using the disclosed technology;

FIG. 9B is still another example table of results from using the disclosed technology; and

FIG. 10 is a schematic diagram that shows an example of a computing device and a mobile computing device for use in conjunction with the processes of the present disclosure.

### DESCRIPTION OF ILLUSTRATIVE EMBODIMENTS

Certain embodiments will now be described to provide an overall understanding of the principles of the methods and systems disclosed herein. One or more examples of these embodiments are illustrated in the accompanying drawings. Those skilled in the art will understand that the methods and systems specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. In the present disclosure, like-number components of various embodiments generally have similar features when those components are of a similar nature and/or serve a similar purpose, unless otherwise noted or otherwise understood by a person skilled in the art.

This disclosure generally relates to technology for verifying models, such as neural networks, against perturbations in a filter space of a convolution operation.

In the following disclosure, bold lower case letters a can be used to denote vectors with a[i] representing the i-th element of a vector, bold upper case letters A can be used to denote matrices with A[i, j] to denote the element in the i-th row and j-th column of a matrix, and ∥α∥_{∞}:=supᵢ|x[i]| for the l_{∞} norm of a vector. At least because the disclosed technology provides illustrative examples of neural networks for image processing, the input of a given network can be an image, and therefore can refer to single entries in an input matrix as pixels. The neural networks for image processing are merely illustrative examples; the disclosed technology can also be applied for verifying/robustifying other types of models and/or neural networks.

A feed-forward neural network (FFNN) is a function ƒ(x): [symbol] ⁿ^{₀}→ [symbol] ⁿ^{_{L}}, which is defined using the concatenation of L∈ [symbol] layers. Each layer itself can implement a function ƒᵢ and it can hold that ƒ(x)=ƒ_{L}(ƒ_{L-1}( . . . (ƒ₁(x))). Given an input x₀ the output of a layer 1≤i≤L can be calculated in a recursive manner by applying the layer's operations to output of a previous layer, e.g., xᵢ=ƒᵢ(xᵢ₋₁). The operation encoded by the i-th layer can be ƒᵢ: [symbol] ⁿ^{ᵢ₋₁}→ [symbol] ⁿ^{ᵢ} where nᵢ can be the number of neurons in that layer. It can be assumed that each layer operation ƒᵢ includes two components: firstly, the application of a linear map αᵢ: [symbol] ⁿ^{ᵢ₋₁}→ [symbol] ⁿ^{ᵢ}, xᵢ₋₁ [symbol] Wᵢxᵢ₋₁+bᵢ for a weight matrix Wᵢ∈ [symbol] ⁿ^{ᵢ}^{×n}^{ᵢ₋₁} and a bias vector bᵢ∈ [symbol] ⁿ^{ᵢ} that can yield a pre-activation vector \hat{x}ᵢ. Secondly, the element-wise application of an activation function σᵢ: [symbol] ⁿ^{ᵢ}→ [symbol] ⁿ^{ᵢ} can yield the post-activation vector xᵢ. Networks may be assumed to use a piece-wise Rectified Linear Unit (ReLU) function ReLU(x)=max(0, x), but verification can be equally possible for other activations, such as sigmoid and/or tanh functions. A last layer of a given network normally may not include an activation function, σ_{L} and therefore would be the identity map. As an illustrative example, the disclosed technology is described with respect to networks performing image classification where the input x₀ can be an image that needs to be categorized as belonging to one out of c classes. The final layer outputs n_{L}=c classification scores and the predicted class for an image can be j=arg maxᵢx_{L}[i].

Given a trained network ƒ, the verification problem can include formally showing that an output of a network is contained in a linearly definable set [symbol] ⊂ [symbol] ⁿ^{_{L}} for all inputs in a linearly definable input set [symbol] ⊂ [symbol] ⁿ^{₀}. Formally, the disclosed technology provides that:

$$∀ {x}_{0} ∈ 𝒥 : f ( {x}_{0} ) ∈ 𝒪 .$$

Inspired by adversarial attack paradigms, most works study local robustness of networks to white noise constrained by the l_{∞} norm. Given an input x̅∈ [symbol] ⁿ^{₀}, which the network correctly classifies as belonging to class j′, most works do so by defining the input and output sets as:

$$𝒥 = \{ x ∈ {ℝ}^{{n}_{0}} \vert {‖ x - \overline{x} ‖}_{∞} \leq ϵ \}$$

$$𝒪 = \{ y ∈ {ℝ}^{{n}_{L}} \vert y [ {j}^{′} ] > y [ i ] ∀ j \neq {j}^{′} \}$$

where ∈ can be a perturbation size for which the verification query should be solved.

State of the Art verifiers often employ bound propagation of some kind. If bounds obtained at the final layer are tight enough, they can be used to answer the verification problem. A difficulty in these approaches lies in the nonlinearity of the network activation functions. Convex relaxations of the functions may be employed, but they can induce an over approximation error, which can become significant for larger networks. If the over-approximation that was introduced is too large, a Branch-and-Bound (BaB) strategy may be employed to split the problem into multiple subproblems with refined relaxations being used in each of those subproblems. One branching strategy includes input splitting, which partitions an input space into subspaces. This can be used for networks with low input dimensions. Neuron splitting can also be used for networks with high-dimensional perturbations where input splitting may be less effective. This strategy can split the input space of a single neuron in the network into subspaces to allow for a more precise encoding of the activation functions. In an example of piece-wise ReLU activation functions, this can be done by splitting the function into its two linear pieces. Verification for high-dimensional perturbations, such as norm-based ones, can normally be more challenging than verification for low-dimensional properties, such as brightness or contrast. This can be due, at least in part, to the dimensionality of perturbations and BaB strategies described herein. In the illustrative l_{∞} case, each neuron can be perturbed independently, which can result in a high-dimensional optimization problem and looser bounds for each neuron. Verifiers often need to split a substantial number of neurons and explore numerous branches in the BaB tree to answer the verification problem. At the same time, for identical input sizes, verification of robustness against brightness perturbations can be easier, due, at least in part, to the fact that for a given input x̅ the perturbations for all entries of x̅ may be coupled.

For example, the input set for a brightness perturbation is

$$𝒥 = \{ x ∈ {ℝ}^{{n}_{0}} \vert x = \overline{x} + 1 β , β ∈ [ - ϵ , ϵ ] \}$$

with 1∈ [symbol] ⁿ^{₀} being a column vector of ones and β a scalar. The verification problem therefore can have a dimensionality of 1, which means that it can effectively be tackled using input splitting. The typical return values of the verifiers can include safe (the network is robust under the given perturbation), undecided (the verifier could neither verify nor falsify the query, for example due to overly coarse relaxations), or unsafe (a concrete counterexample for which the network returns an incorrect result was found in the space of allowed perturbations).

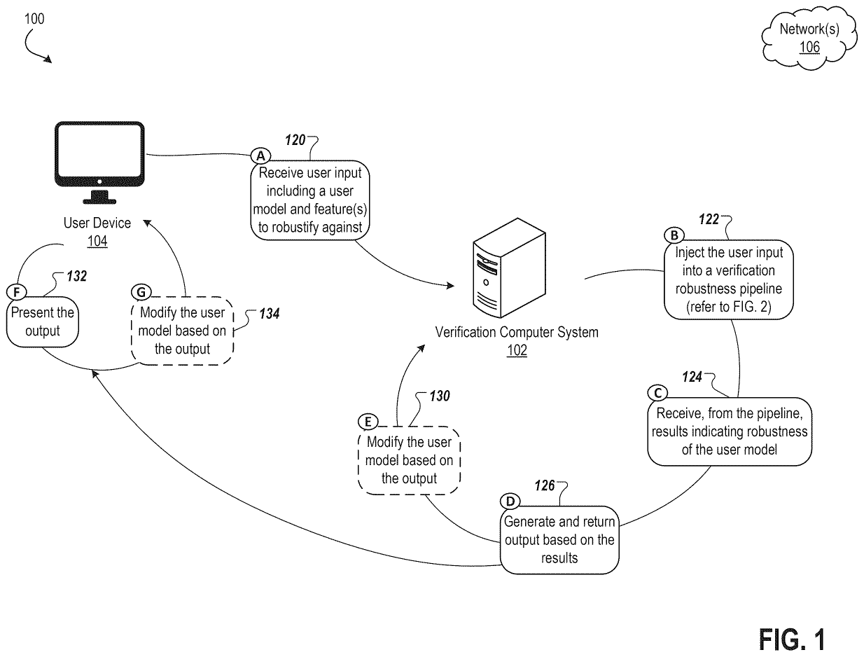

Referring to the figures, FIG. 1 is a conceptual diagram of a system 100 for verifying a model, such as a neural network, for robustness against convolutional perturbations in a verification pipeline. The system 100 can include a verification computer system 102 in network communication (e.g., wired, wireless) with a user device 104 via network(s) 106. The verification computer system 102 can be a computing system, server, and/or cloud-based system that can be configured to execute or otherwise perform a robustness verification pipeline as described herein. In some implementations, the robustness verification pipeline described herein can be performed remotely and/or at the user device 104 having appropriate programming language (e.g., Python) and hardware components (e.g., CPU cores, memory, and/or GPU, among others) to run the pipeline, and in least some instances the pipeline can be performed on any system(s) capable of executing machine learning models, including edge-based devices. The user device 104 can be a computing device, laptop, tablet, mobile phone, computer, and/or smartphone.

As shown in the system 100, the verification computer system 102 can receive, from the user device 104, user input, including at least a user model and/or features to robustify against (block A, 120).

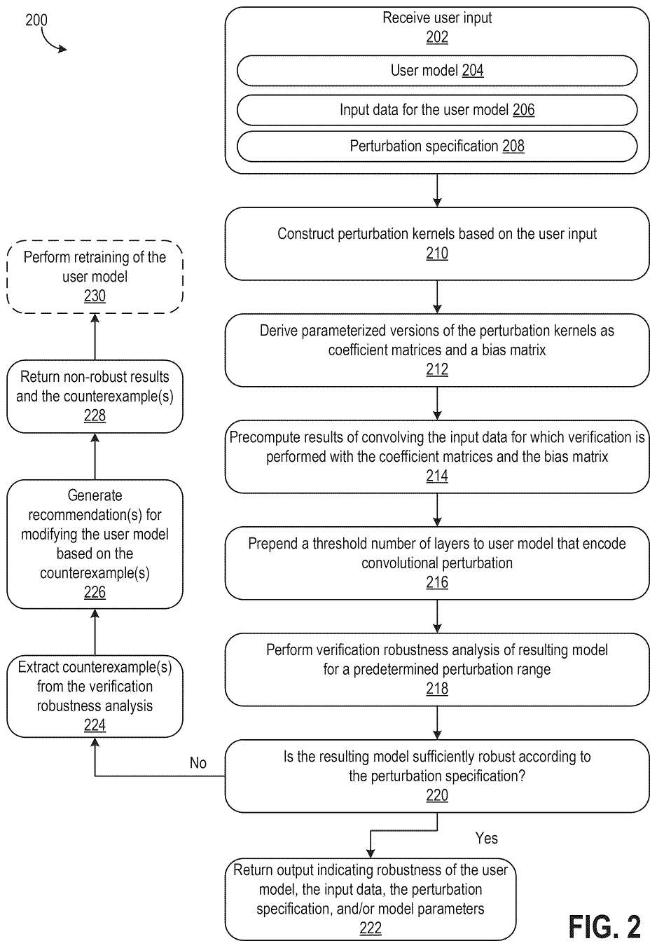

The verification computer system 102 can inject the user input into the robustness verification pipeline in block B (122). Refer to FIG. 2 for further discussion about performing or executing the pipeline.

In block C (124), the verification computer system 102 can receive, from the pipeline, results indicating robustness of the user model.

Accordingly, the system 102 can generate and return output based on the results (block D, 126).

Optionally, the verification computer system 102 may modify, finetune, and/or retrain the user model based on the output (block E, 130). In response to modifying the user model, the verification computer system 102 can return the modified model to the user device 104 and/or a computing system that is configured to deploy and run the modified model. At least sometimes, the modified model can be transmitted to the user device 104 and presented to the user. The user can review the modified model, further modify the model, and/or deploy the model for runtime use at the user device 104 and/or at another system(s). In yet some implementations, the modified model can be fed back into the verification computer system 102 to be further checked before deployment at the user device 104 and/or another deployment computer system(s).

In at least some implementations, blocks C (124), D (126), and E (130) can be performed in a robustness verification pipeline that is executed by the verification computer system 102 and/or another computing system(s).

Additionally, and/or alternatively, the verification computer system 102 can return the output to the user device 104, which can be configured to present the output in one or more graphical user interfaces (GUIs) displayed at the user device 104 (block F, 132). The user device 104 may optionally modify the user model based on the output (block G, 134). For example, a user can provide user input at the device 104 to adjust, modify, retrain, and/or finetune the model accordingly to the output. Sometimes the user device 104 can automatically modify the model based on the output in block G (134).

FIG. 2 is a flowchart of an example of a process 200 for verifying a model against convolutional perturbations using parameterized kernels.

The process 200 can be performed by components of the verification computer system 102 described herein. The process 200 can also be performed by one or more other software modules, applications, and/or engines that are programmed to perform the disclosed techniques. Such software modules, applications, and/or engines can be implemented by one or more computing systems, devices, computers, networks, cloud-based systems, and/or cloud-based services. For illustrative purposes, the process 200 is described from the perspective of a computer system. Further, one or more of the actions disclosed in the flowchart of FIG. 2 can be modified, skipped over, removed, and/or replaced without departing from the spirit of the present disclosure. The inclusion of all the disclosed actions in FIG. 2 does not require that all such actions must be performed. It is contemplated that other methods supported by the present disclosure may be directed to any subset of the actions provided for in the figure, and that other actions can also be included with any portion of the actions provided for in the illustrated flowchart.

Referring to the process 200 in FIG. 2, the computer system can receive user input in block 202. The user input can identify a particular verification problem of interest for the user. The user input can include but is not limited to a user model (block 204), input data for the user model (block 206), and/or a perturbation specification (block 208). The user model (block 204) can include a trained neural network (NN) having an architecture and one or more parameters. The input data for the model (block 206) may include but is not limited to images (e.g., still images, video). The perturbation specification (block 208) can include but is not limited to perturbation kernels of interest (e.g., box blur kernels, sharpen kernels, motion blur kernels), parameters for the perturbation kernels, such as size of the kernel and/or perturbation-specific parameters (e.g., angle of motion blur), maximum perturbation strength (e.g., ‘epsilon’) to consider for robustness verification, and/or any combination thereof.

In block 210, the computer system can construct perturbation kernels based, at least in part, on the user input. At least sometimes the user input may specify the perturbation kernel(s) to be used. One or more other perturbation kernels may also be used that may not be specified by the user input.

The computer system can derive parameterized versions of the perturbation kernels as coefficient matrices and a bias matrix in block 212. The computer system can derive the parameterized versions such that the derivation is equal to an identity kernel for z=0 and a given perturbation kernel for z=1. This can result in the one or more coefficient matrices Aᵢ and the bias matrix B.

The computer system can precompute results of convolving the input data for which verification is performed with the coefficient matrices and the bias matrix (block 214). In other words, the computer system can separately precompute the results of convolving the input images with the coefficient kernels A_i and the bias kernel B.

In block 216, the computer system can prepend a threshold number of layers to the user model that are configured to encode convolutional perturbations. The computer system can prepend the layers by using standard layers (e.g., matrix multiplication, reshape). Other layers may also be used. The number of layers can vary at least based on perturbations to be encoded and/or one or more parameters that are designated by the relevant user. As an illustrative example, two layers can be used-one for encoding the actual perturbation (e.g., which outputs a vector) and one layer for reshaping the outputted vector into a format of an image (e.g., number of pixels along x axis, number of pixels along y axis, number of channels in the image). If the user specifies that additional operations should be performed (e.g., clipping the output of the perturbation to a valid interval), then more layers may be included.

In block 218, the computer system can perform a robustness verification analysis of the model resulting from block 216 for a predetermined perturbation range. The predetermined perturbation range can be defined by the user in the perturbation specification and/or the user input, more generally. Existing verification and/or robustness techniques may be used to perform block 218.

The computer system can determine whether the resulting model is sufficiently robust according to the perturbation specification (block 220). For example, the user can define a perturbation strength up to which a model should be invariant for it to be considered robust. The user can specify, as an illustrative example, that a motion blur perturbation up to a strength of 0.5 is what the model needs to be invariant (e.g., still producing a correct output under a perturbation of any strength up to 0.5) for it to be considered robust. The user-defined perturbation strength or other criterion for use in block 220 can depend, at least in part, on a particular use case or application. For example, in critical applications, the user may specify a higher threshold, and thus higher requirements for the model to be considered robust. By way of non-limiting examples, the requirements defined by the user may be, in at least some instances, defined by regulators and/or certifying authorities, and/or be informed by one or more risk assessment studies.

If the model is sufficiently robust, the computer system can return output indicating the robustness of the user model, the input data, the perturbation specification, and/or model parameters (block 222). For example, the output can indicate what perturbations (e.g., blur at a particular angle) the user model is robust against.

If the model is not sufficiently robust, the computer system can extract counterexamples from the robustness verification analysis in block 224. The counterexamples can be perturbed images that may produce the lack of robustness or otherwise fool the user model during execution.

The computer system can also generate recommendations for modifying the user model based, at least in part, on the counterexamples (block 226). The recommendations can include one or more of retraining the model, fine-tuning the model based on the counterexamples, repairing the model using one or more repair techniques, etc.

Accordingly, the computer system can return non-robust results and/or the counterexamples (block 228). The results can be returned to a user device described herein or otherwise known to those skilled in the art.

The computer system can optionally perform retraining of the user model based, at least in part, on the non-robust results, the counterexamples, and/or the generated recommendations in block 230.

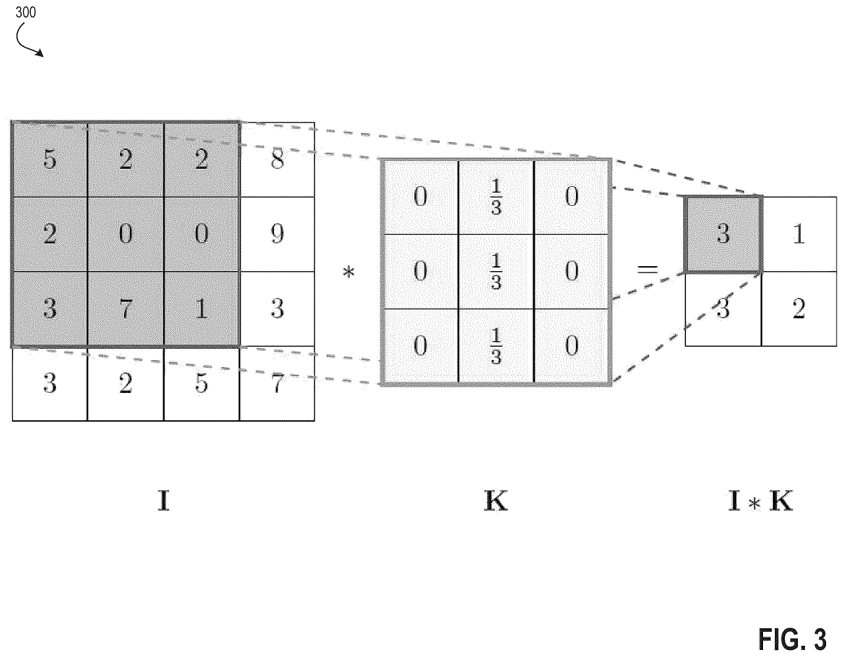

FIG. 3 illustrates an example 300 of a convolution of an input I with a kernel K. Convolution is a mathematical operation that can be used for processing inputs in signal processing. Most relevant here is the discrete convolution operation on two-dimensional inputs, including but not limited to images. For a given input matrix, convolution can be used by the disclosed system to compute each element in an output matrix by multiplying a corresponding input value and its neighbors with different weights, then summing over the results as shown in the example 300. Given a two-dimensional input matrix I and a kernel matrix K, the convolution of I with K, often written as I*K, can be defined as:

$$I * K [ i , j ] = {\sum }_{k , l} I [ i + k , j + l ] K [ k , l ]$$

Here (i, j) can be a tuple of valid indices for the result, and the output shape of I*K can be computed based on a number of parameters. In signal processing, the convolution operation can include flipping the kernel K before convolving the input with it. In machine learning, however, the operation without flipping the kernel can often be referred to as convolution as well, and deep learning frameworks, such as PyTorch, may implement convolution without the kernel flipping. The elements of K can be normalized to sum to 1, for example if I is an image, at least because this can preserve brightness of the image. The output of the convolution can be a smaller size than the input, for example if an output of identical size is required. Padding can be added to the image before the convolution, at least in some implementations.

In the illustrative example 300, it can be assumed that no padding is used and the input image I and the kernel K can be defined as:

$$I = ( \begin{matrix}5 & 2 & 2 & 8 \\ 2 & 0 & 0 & 9 \\ 3 & 7 & 1 & 3 \\ 3 & 2 & 5 & 7\end{matrix} ) , K = ( \begin{matrix}0 & \frac{1}{3} & 0 \\ 0 & \frac{1}{3} & 0 \\ 0 & \frac{1}{3} & 0\end{matrix} )$$

The result of the convolution of I with K is shown in the example 300 of FIG. 3.

When the kernel slides across the image, output values for pixels near a center of the image can be computed. For pixels near the image's border, however, there may be situations where centering the kernel on a given pixel can lead to some fields of the kernel being outside the bounds of the image. One way of solving this issue can be to only compute output values for pixels for which the kernel lies entirely within the bounds of the image. This implies that the size of the output image may be smaller than that of the input. If shape is to be preserved, padding can be added around the image. There are different strategies for filling the pixels in this area with values such as zero padding (e.g., filling all fields with zeros) and/or reflection padding (e.g., reflect pixels from inside the image to fill the padding pixels). In early image processing algorithms, linear filtering methods, such as convolutions, could be used. The applications could be, for example, edge detection or denoising. The kernels could be carefully designed. Convolutional neural networks learn these kernels from data to perform a variety of tasks, such as classification and/or object detection. When using suitable kernels, convolution can be used to apply effects, such as sharpening, to an image. This disclosure provides an illustrative example of focusing on verification against camera shake and/or motion blur while also considering box blur and sharpen to demonstrate generalization of the disclosed technology to other perturbations.

An existing system for verifying the robustness of a network to convolutional perturbations can define a neighborhood of a pixel in the input space for a given kernel size k input image I∈ [symbol] ^{d}^{₁}^{×d}^{₂} and a pixel location tuple (i, j) as the set of pixels inside a box of size k×k centered at the position (i, j). Fields of the box that lie outside the bounds of the input image can be disregarded. A lower bound l and upper bound u for each pixel can be calculated as the minimum and maximum element in that neighborhood, respectively. These bounds may be tight in the sense that they are attainable: the lower bound for a pixel can be realized through a kernel that has a 1 entry at a location of the minimum in the pixel's neighborhood and zero elsewhere. A similar construction can be possible for the maximum. If this operation is repeated for each pixel in the input image, two matrices—L∈ [symbol] ^{d}^{₁}^{×d}^{₂} and U∈ [symbol] ^{d}^{₁}^{×d}^{₂}—with lower and upper bounds for each pixel can be obtained. A standard verifier can be used to certify robustness for a network on the given input by treating the perturbation as an l_{∞} perturbation, assuming that each pixel can vary independently between its lower and upper bound.

If verification is successful, the network can be certified to be robust to any convolutional perturbation for which the values of the kernel lie in the [0, 1] interval. However, at least because the robustness specification may be general, the bounds that are obtained from the method can be loose. The assumption that variations of pixels are not coupled also means that the perturbation may be high dimensional, leading to long runtimes and even looser bounds in layers deeper in the network. The combination of these factors means that even for the smallest kernel size of 3, the existing systems may obtain a verified accuracy of about 30% in the best case and 0% in the worst case for small classifiers trained on training datasets (e.g., MNIST and/or CIFAR10). The existing systems are therefore unlikely to scale to larger networks.

Phenomena such as motion blur cannot be modeled using the existing systems, such as l_{∞} perturbations since the computation of each output pixel's value is based not only on its original value, but also on the values of its neighboring pixels. The disclosed technology can provide for parameterizing specific kernels to model perturbations using convolution, allowing for the certification of robustness to specific types of convolutional perturbations while yielding tighter bounds. An advantage of the disclosed technology is its simplicity. It can be implemented using operations from a machine learning library to calculate the parameters of a linear layer prepended to the network to be verified.

The disclosed technology can use linearly parameterized kernels in the convolution operation. A kernel can be linearly parameterized if each entry in the kernel matrix is an affine expression depending on a number of m variables. When convolving a constant input with such a kernel, the result can again be a linear expression because of the linearity of the convolution operation.

Still referring to FIG. 3, in a first theorem, it can be assumed that an input image I and a parameterized kernel K can be defined as

$$K = {\sum }_{i = 1}^{m} {A}_{i} \cdot {z}_{i} + B$$

where zᵢ∈ [symbol] . Aᵢ and B can be a number of coefficient matrices and a bias matrix, respectively, which have the same shape as K. Then there can be:

$$I * K = {\sum }_{i = 1}^{m} ( I * {A}_{i} ) {z}_{i} + I * B \qquad ( 1 )$$

This theorem can allow for computing the result of a convolution with a parameterized kernel by separately convolving the input with each coefficient matrix and the bias matrix (Equation 1). The zᵢ variables can be ignored during these computations, which means that the convolution operations need to only be executed on (m+1) constant matrices. Convolution implementations from a machine learning library can be used for this computation, at least in some implementations.

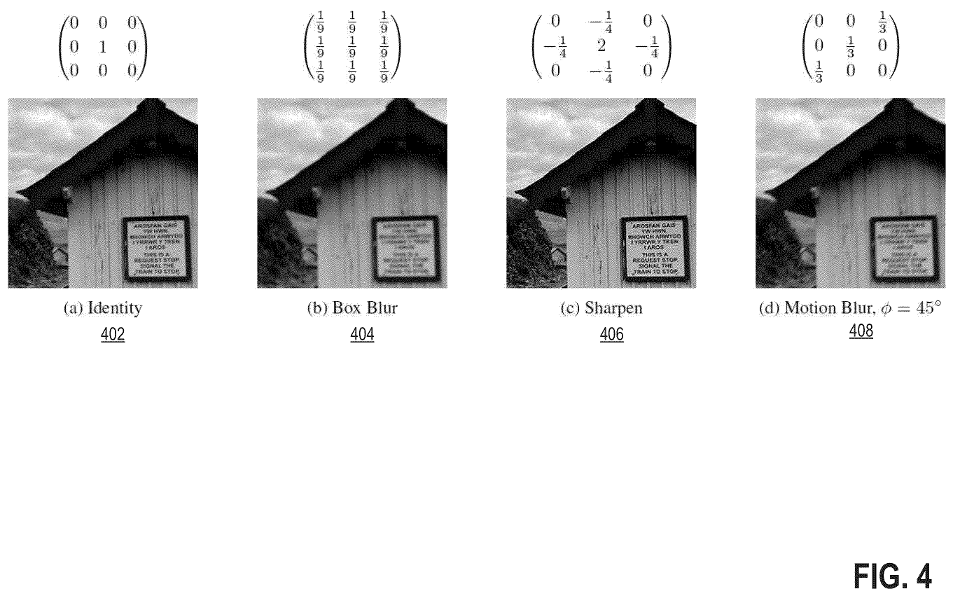

FIG. 4 illustrates example visualizations of kernels 402, 404, 406, and 408 used in the disclosed verification pipeline. Such kernels can include the identity kernel 402, the box blur kernel 404, the sharpen kernel 406, and/or the motion blur kernel with a predetermined angle and/or axis 408. The effect each of these kernels 402, 404, 406, and 408 has on an image is also shown in FIG. 4. Note that for inputs with multiple color channels, the convolution can be performed independently for each channel.

As described herein, a user associated with a network and/or model can designate what types of perturbations to robustify a model against. The user can identify, for example, which of the kernels 404, 406, and/or 408 ought to be selected and applied in the verification pipeline described herein. The kernel 402 is an identity kernel, which does not perturb an image.

To enable verification of a network to a range of perturbation strengths, a linear transition can be modeled from an identity kernel to a desired perturbation kernel P using a variable z∈[0,1]. Two initial conditions can be given for the kernel, which can be equal to the identity kernel for z=0, and equal to the desired perturbation kernel, such as those kernels 404, 406, and 408 in FIG. 4 for z=1. An affine function can be unambiguously defined by these two points (that it intercepts), and the disclosed technology can compute slope and intercept for each entry in the kernel. Example 2 below shows this derivation for a 3×3 motion blur kernel with a blur angle of φ=45°, shown by the kernel 408 in FIG. 4.

### Example 2

The initial conditions for the above-described parameterization can include:

$${P}_{z = 0} = ( \begin{matrix}0 & 0 & 0 \\ 0 & 1 & 0 \\ 0 & 0 & 0\end{matrix} ) , {P}_{z = 1} = ( \begin{matrix}0 & 0 & \frac{1}{3} \\ 0 & \frac{1}{3} & 0 \\ \frac{1}{3} & 0 & 0\end{matrix} )$$

It can be assumed that each kernel entry can be of the form p(z)=az+b where z∈ [symbol] is a variable and a, b∈ [symbol] are parameters. At least because there are two unknowns a, b and two points that the function passes through from the initial conditions, the disclosed technology can solve for a, b to obtain parameters for each kernel entry. In the camera shake example, for φ=45°, there can be three types of entries: center entry, non-center entries on the antidiagonal running from top right to bottom left of the matrix, and entries that do not lie on the antidiagonal.

For parameterization for the center entry, the following can be defined p(0)=1 and

$$p ( 1 ) = \frac{1}{3} .$$

This can result in the following constraints:

$$p ( 0 ) = 1 = a \cdot 0 + b \qquad ( 2 )$$

$$p ( 1 ) = \frac{1}{3} = a \cdot 1 + b \qquad ( 3 )$$

Solving for a, b yields

$$a = - \frac{2}{3} ,$$

b=1 and therefore

$$p ( z ) = - \frac{2}{3} z + 1 .$$

For parameterization for the antidiagonal entries (i.e., non-center entries on the antidiagonal), the initial conditions can be:

$$p ( 0 ) = 0 = a \cdot 0 + b \qquad ( 4 )$$

$$p ( 1 ) = \frac{1}{3} = a \cdot 1 + b \qquad ( 5 )$$

Equation 4 implies that b=0 and then

$$a = \frac{1}{3}$$

follows from Equation 5. Accordingly,

$$p ( z ) = \frac{1}{3} z$$

can be determined.

For parameterization for the off-antidiagonal entries, the following can be defined as p(0)=p(1)=0 and therefore p(z)=0.

In conclusion, P=A·z+B can be determined with:

$$A = ( \begin{matrix}0 & 0 & \frac{1}{3} \\ 0 & - \frac{2}{3} & 0 \\ \frac{1}{3} & 0 & 0\end{matrix} ) , B = ( \begin{matrix}0 & 0 & 0 \\ 0 & 1 & 0 \\ 0 & 0 & 0\end{matrix} )$$

Similar to the above, parameterizations can be derived for other kernel sizes, different motion blur angles, and/or other perturbations, including but not limited to blur and/or sharpen. For even kernel sizes, an identity kernel can be approximated by defining four entries around a true center of the kernel to have a value of ½ with all other values being zero. However, this kernel may still add a noticeable blur to the image.

Referring to the process 200 in FIG. 2 and the examples provided for in FIGS. 3 and 4, and given the parameterized kernels described herein, the disclosed technology can use Theorem 1 to easily verify the robustness of neural networks to the perturbations the kernels encode. At least because the parameterized kernels only depend on a single variable, indexing of the variable z and the coefficient matrix A can be omitted. Additional layers can also be used that encode a perturbation, which are then prepended to a network for verification.

Assume a trained neural network ƒ is given together with a correctly classified input image in vectorized form x̅∈ [symbol] ^{o}^{_{c}}^{·o}^{ₕ}^{·o}^{_{w}} where o_{c}, oₕ, o_{w} are the image's number of channels, height, and width, respectively. The vector x̅ can be reshaped into the original shape of the image (o_{c}, oₕ, o_{w}) to obtain an input tensor I. This step can be performed for the convolution operation to be applicable. The disclosed technology can then separately convolve I with A and B to obtain R_{A}:=(I*A) and R_{B}:=(I*B). For inputs with multiple channels, each channel can be convolved independently with the same kernels A, B so the output of the convolution has the same number of channels as the input.

To encode the perturbation in a network layer, the disclosed technology can reshape the resulting matrices of these convolutions to be vectors r_{A}, r_{B} ∈ [symbol] ^{o}^{_{c}}^{·o}^{ₕ}^{·o}^{_{w}} again. The disclosed technology can also prepend a matrix multiplication layer to the network that computes Ã·z+\tilde{B} where Ã=r_{A}, \tilde{B}=r_{B} are parameters for the layer that are set for each verification query and z∈ [symbol] is the input to the network controlling the strength of the perturbation. The image information can now be encoded in the parameters of this new layer. Despite the fact that all parameterizations depend on one variable, the disclosed method generalizes to the case where the number of coefficient matrices in the parameterization m is greater than one. In those cases, m+1 can be performed to separate convolutions and obtain m matrices R_{A}_{₁}, . . . , R_{A}_{ₘ} and one matrix R_{B} that can be reshaped into vectors r_{A}_{₁}, . . . , r_{A}_{ₘ}, r_{B}. Assuming r_{A}_{ᵢ}∈ [symbol] ^{o}^{_{c}}^{·o}^{ₕ}^{·o}^{_{w}} are column vectors, they can be concatenated horizontally to form a parameter matrix Ã∈ [symbol] ^{o}^{_{c}}^{·o}^{ₕ}^{·o}^{_{w}}. The input to the network in this case can be a vector z∈ [symbol] ^{m} for parameterizing the perturbation. The prepended layer then computes the matrix-vector product Ã_{z}, adds the bias B to it and feeds the resulting vector of size o_{c}·oₕ·o_{w} into the first layer of the original network. The robustness of the resulting network can be checked by using neural network verifiers. At least because the input to the augmented network is low-dimensional (e.g., one-dimensional), input splitting as a branching strategy is particularly effective for verification.

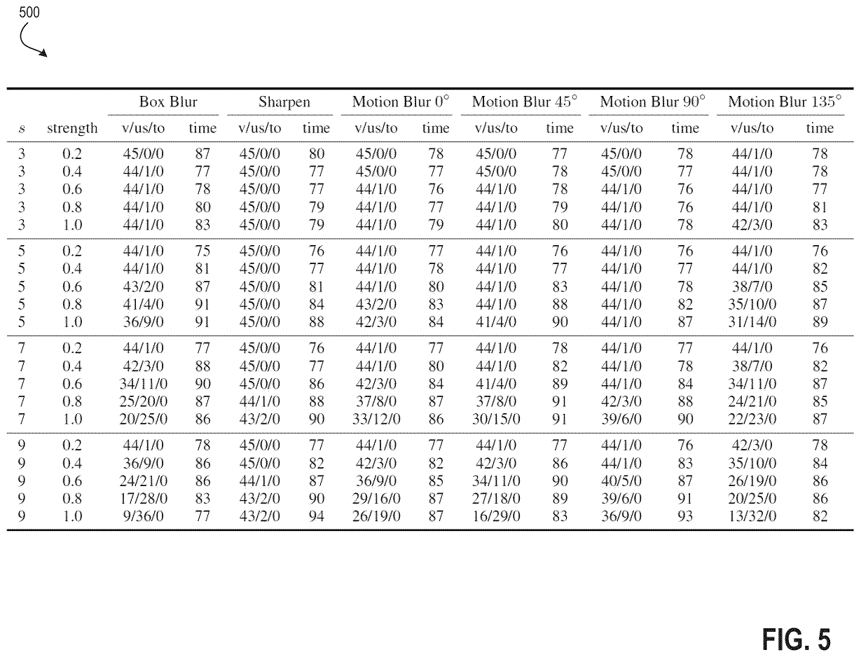

FIG. 5 is an example table 500 of results from using the disclosed verification pipeline. As a non-limiting illustrative example, the experimental evaluation shown in the table 500 were performed on the mnist_fc dataset. For the mnist_fc dataset, it can be said that these are fully-connected neural networks that are trained on the MNIST dataset to perform handwritten digit recognition. The experimental evaluation can also be performed using other standard benchmarks known to those skilled in the art. One or more other datasets may also be used for performing the experimental evaluation. By way of non-limiting example, each query can be run with a timeout of about 1800 seconds. s can be the filter size and v/us/to can denote the number of verified/unsafe/timeout instances, respectively.

The table 500 indicates that for the mnist_fc benchmark, the networks trained to perform classification for the MNIST dataset are robust to sharpen perturbations. They can be comparably vulnerable to box blur perturbations. For motion blur, the robustness depends, at least in part, on a blurring angle. For example, the table 500 shows that networks can be relatively vulnerable to 45 degree and 135 degree blurring and more robust to blurring along the 0 degree and 90 degree axis.

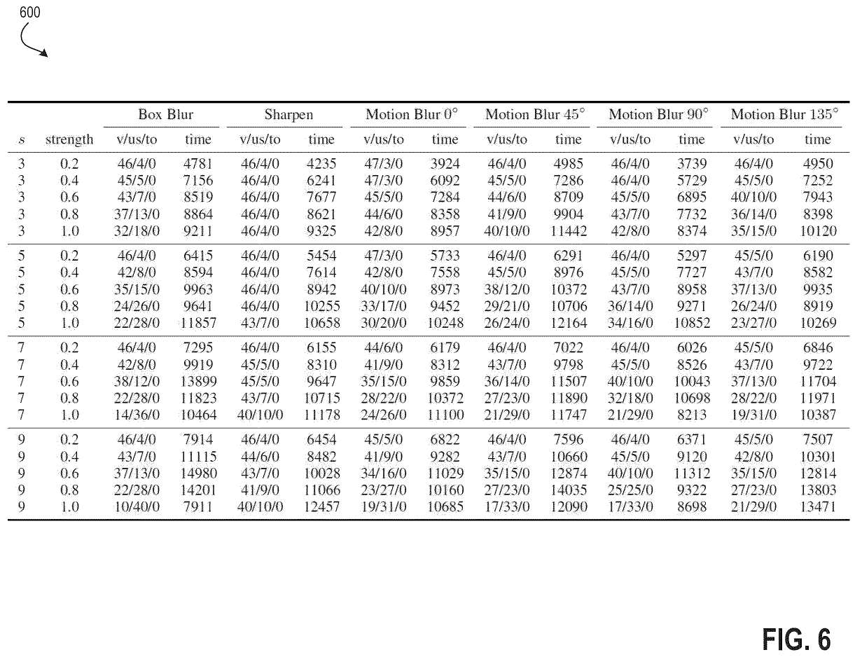

FIG. 6 is another example table 600 of results from using the disclosed verification pipeline. Here, the non-limiting illustrative experimental evaluation was performed on the ResNet-18 dataset. The ResNet-18 dataset can be built with a standard network architecture, which can be used in computer vision techniques. The network can be trained, for example, on the CIFAR10 dataset or other similar standard datasets to perform image classification and predict a class of a given image out of one or more possible classes. Unlike at least some other datasets provided for herein, in this instance the ResNet-18 dataset is not a standard dataset. Rather, this dataset was created to showcase that the disclosed methods and systems scale well to large networks. By way of non-limiting example, each query can be run with a timeout of about 1800 seconds. s can be the filter size and v/us/to can denote the number of verified/unsafe/timeout instances, respectively.

The table 600 demonstrates that the disclosed technology scales to larger networks. For example, the ResNet-18 dataset can be considered a fairly large computer vision model, yet, the disclosed technology still verifies robustness for it. As shown in the results table 600, the network is relatively robust to sharpen perturbations, less robust to motion blur along various angles, and least robust to box blurring. At least because this is a larger network, it can be more challenging to verify robustness for it than it is for a small network like the ones used in the mnist_fc benchmark.

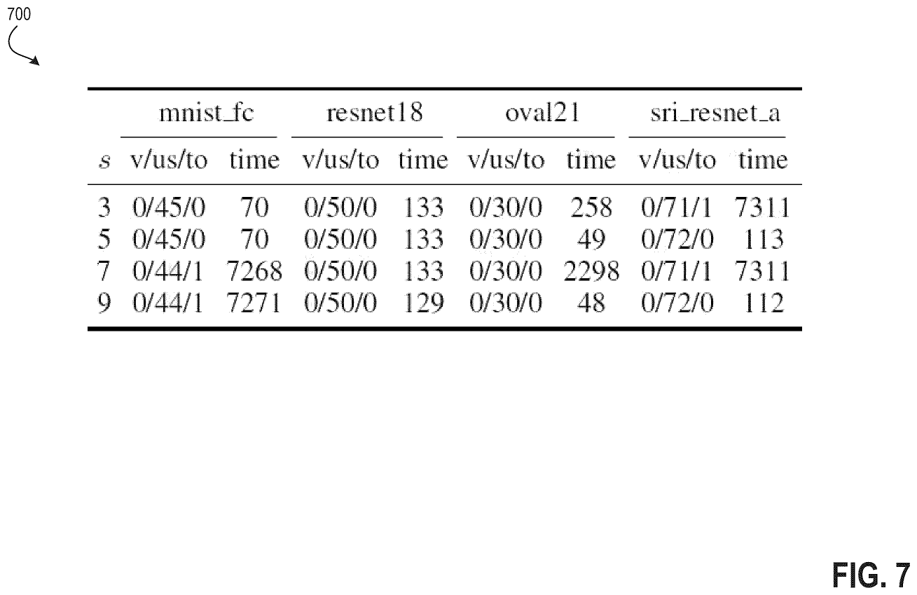

FIG. 7 is an example table 700 of an ablation study using the disclosed verification pipeline. The table 700 results indicate that a previously-existing method for verifying robustness to convolutional perturbations does not scale to any of the models or networks that are analyzed and described herein. The existing methods and systems are imprecise and thus cannot provide robustness certificates for the models/networks analyzed herein. The disclosed technology, on the other hand, can scale to significantly larger networks.

With reference to FIGS. 5, 6, and 7, to evaluate the disclosed technology, a robustness verification toolkit can be employed, which may use Mixed-Integer Linear Programming and/or Symbolic Interval Propagation to solve verification problems. The toolkit can be extended to process modified vnnlib files, which encoded the perturbations. Sometimes, the toolkit may use PyTorch for efficient vectorized computations. The disclosed technology can enable its Symbolic Interval Propagation (SIP). This is a known technique in neural network verification, which can enable computation of lower and upper bounds for each neuron in a network under a perturbation. Thus, the disclosed technology can enable its SIP solver and its adversarial attacks engine. The disclosed technology can then build the parameterized kernels as described above and convolve the input with them using one or more convolving operations. An additional layer encoding the perturbation can be prepended to the network as described above, and verification with input splitting can be run on the augmented network.

The performance of robustness verification for the proposed perturbations can be evaluated on benchmarks. The mnist_fc dataset can be a classification benchmark that includes three different networks with 2, 4, and 6 layers with 256 ReLU nodes each that is trained on the MNIST dataset. Oval21 a standard benchmark, can contain three convolutional networks trained on the CIFAR10 dataset. Two of them can include two convolutional layers followed by two fully-connected layers, while the third one can have two additional convolutional layers, the number of network activations ranging from, for example, 3172 to 6756. Sri_resnet_a can be a, ReLU-based ResNet with one convolutional layer, three ResBlocks, and two fully-connected layers trained using adversarial training on the illustrative CIFAR10 dataset. For a resnet18 benchmark, a ResNet18 model can be trained on the CIFAR10 dataset, for example using standard neural network training techniques. The network can have, for example, 11.7 M parameters. For each benchmark, the disclosed technology can change the perturbation type before running the experiments. The timeout for each query can be set to, for example, 1800 seconds. For resnet18, the disclosed technology can select approximately 50 correctly classified instances from the CIFAR10 test set for verification.

For each of the benchmarks, and by way of non-limiting examples, the disclosed technology can test perturbations with kernel sizes of 3, 5, 7, and/or 9. The disclosed technology can vary the upper bound of the perturbation strength that can be denoted as strength in the following, while the lower bound for the strength can be zero. For example, a perturbation strength of 0.4 means that for the parameterized kernel, the variable z can be allowed to vary within the interval [0, 0.4].

The results from the disclosed technology indicate that it scales well to large networks such as ResNet18. The kernel size and perturbation strength can have a larger impact on the verifiability of a model than its size. Verification on all benchmarks was found to be fast due, at least in part, to the low dimensionality of the perturbations. Verification for small perturbation strengths was successful for nearly all instances, irrespective of the kernel size s. For small kernel sizes, such as s=3, verification was successful even for large strengths. For large kernel sizes and large perturbation strengths, unsafe cases were more likely to be found, given that the degree of corruption for e.g., box blur with a kernel size of 9 and a perturbation strength of 1 is substantial. The differences in robustness to different types of perturbations may also be noteworthy. While robustness deteriorated for box blur and camera shake when larger kernel sizes or perturbation strengths were considered, networks retained a high verified robustness against sharpen perturbations. While blurring often induces an information loss, which can make it hard to restore the original information of the image, sharpening emphasizes the image texture and can strengthen edges in the image. This robustness to large sharpen perturbation strengths can be observed for both MNIST and CIFAR10 datasets.

For mnist_fc, robustness of the network to camera shake perturbations was highly dependent on perturbation angle, especially for a kernel size of 9. While the networks were vulnerable to camera shake along the 45° and 135° axis, they were more robust to blurring along the 0° axis. Motion blurring along the 90° axis affected the networks to the least degree with verified accuracies still being extremely high for strong perturbations, even for a kernel size of 9 and a perturbation strength of 1.0. The differences in robustness to different camera shake angles were also observable for resnet18, oval21 and sri_resnet_a, datasets, even though they were less prominent.

At least because the resulting perturbations are high-dimensional, activation splitting can be used instead of input splitting for branching. If a baseline method verifies robustness for a given model, input and kernel size, the model is robust to any perturbation that can be encoded with a kernel of the given size for that input. However, as shown in the table 700 of FIG. 7, the baseline perturbations can lead to loose bounds due, at least in part, to high dimensionality of perturbations combined with already loose bounds for each pixel's value for large neighborhoods. Even for a small kernel size of 3, no properties could be verified for the networks considered. In these cases, bounds became so loose that it could be easy for the verifier to find concrete counterexamples in the majority of cases. The generality of the perturbation specifications in the baseline is one of its strengths, but at the same time limits its practical use at least because it does not scale to larger models or input sizes. The disclosed technology, on the other hand, is less general and requires a separate verification run for each kernel used for modeling a convolutional perturbation. However, the disclosed technology scales to larger networks and therefore enables robustness certification in scenarios where the baseline fails.

In summary, the disclosed technology enables the verification of networks against a range of perturbations that can be modeled through parameterized kernels. The disclosed technology, therefore, provides tight bounds, permitting the verification of much larger networks, and thereby allowing for an efficient verification due, at least in part, to the low dimensionality of the perturbations.

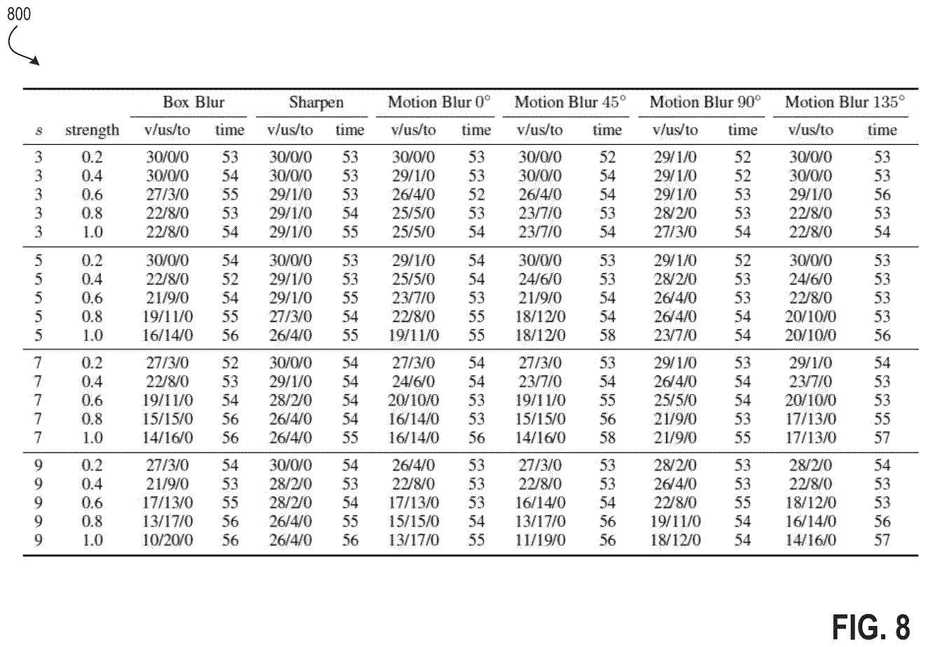

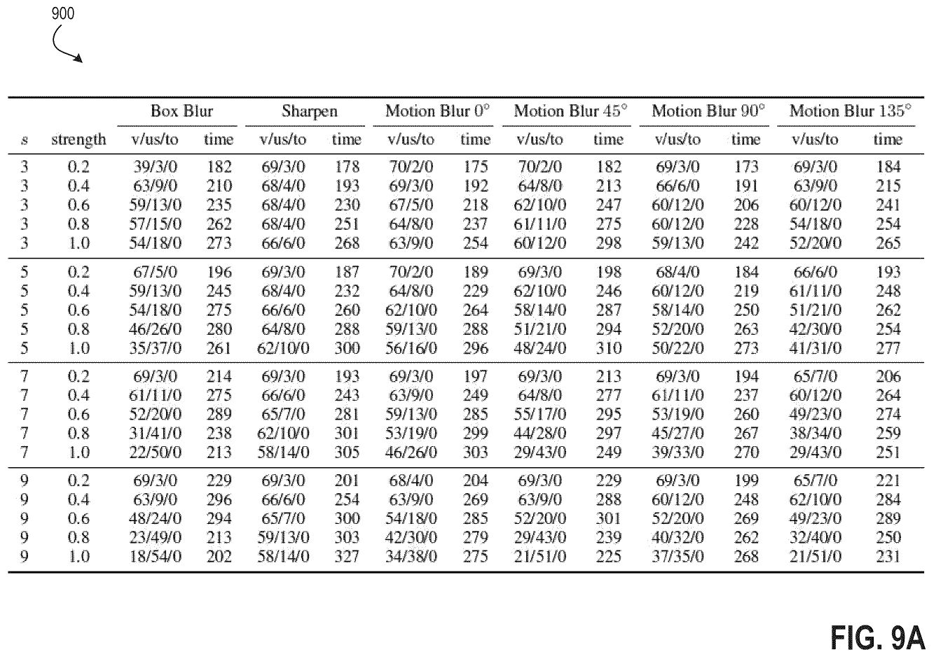

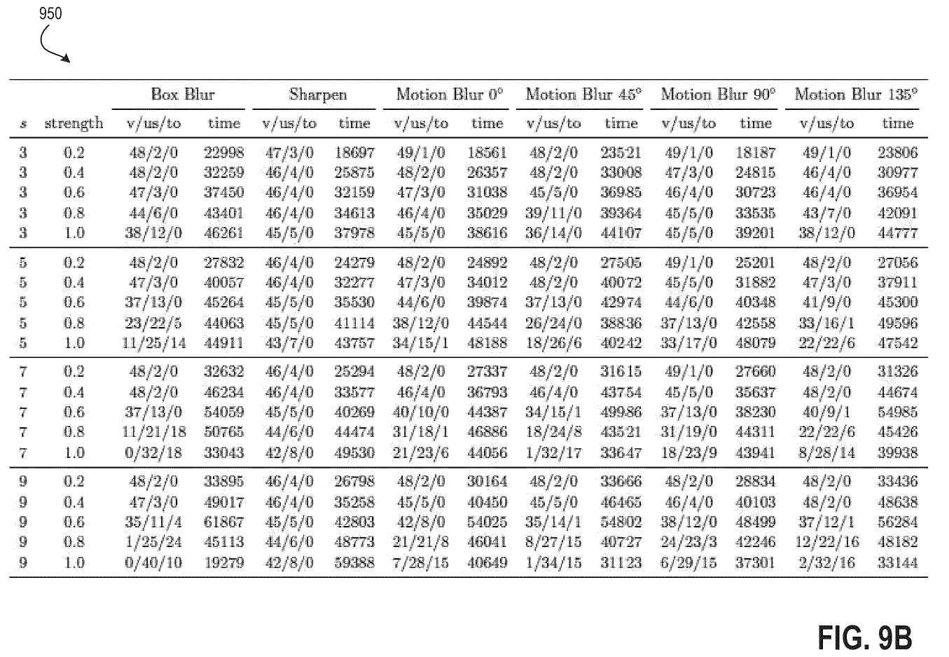

FIG. 8 is an example table 800 of results from using the disclosed technology. FIG. 9A is likewise another example table 900 of results from using the disclosed technology.

Referring to both FIGS. 8 and 9A, an evaluation of the disclosed technology on the illustrative oval21 benchmark is provided in the table 800 and on the sri_resnet_a benchmark in the table 900. The general trends observed on the mnist_fc and resnet18 benchmarks are also observable on these two benchmarks.

Assume to be given a kernel that can be linearly parameterized as:

$$K = {\sum }_{i = 1}^{m} {A}_{i} \cdot {z}_{i} + B$$

where zᵢ∈ [symbol] . Aᵢ and B are a number of coefficient matrices and a bias matrix, respectively, which have the same shape as K. To compute the result of convolving I with K, the linearity of the convolution operation can be exploited to obtain that

$$I * K = {\sum }_{i = 1}^{m} ( I * {A}_{i} ) {z}_{i} + I * B$$

By way of proof, for a kernel K that is parameterized as specified above and an input I, it holds that

$$\begin{matrix}I * K = I * ( {\sum }_{i = 1}^{m} ( {A}_{i} \cdot {z}_{i} ) + B ) \\ = I * {\sum }_{i = 1}^{m} ( {A}_{i} \cdot {z}_{i} ) + I * B\end{matrix}$$

$$= {\sum }_{i = 1}^{m} I * ( {A}_{i} {z}_{i} ) + I * B \qquad ( 6 )$$

$$= {\sum }_{i = 1}^{m} ( I * {A}_{i} ) {z}_{i} + I * B \qquad ( 7 )$$

Equation 6 is already useful at least because it allows the result of the convolution operation to be computed through a number of separate convolutions that can be easier to compute. Equation 7 is arguably the more powerful equation though, at least because it means the result of a convolution with a parameterized kernel can be computed by simply convolving the input under consideration with each coefficient matrix and the bias matrix.

As outlined before, kernels used in a convolution operation can be normalized so that the sum of all kernel entries is one. Identity kernel for z=0 and the target kernel for z=1 can therefore be chosen to have a sum of one. However, from this it is not immediately clear whether the kernel entries for any z∈[0,1] will also sum to one. To prove that this is the case, a lemma can be introduced and used for the proof of the main result.

Lemma 1: Assume to be given h∈ [symbol] , h>1 affine, vector-valued functions gᵢ defined as:

$${g}_{i} ( w ) = {C}_{i} w + {d}_{i}$$

where Cᵢ∈ [symbol] ⁿ^{ₐ}^{×n}^{_{b}} and w∈ [symbol] ⁿ^{_{b}}, d∈ [symbol] ⁿ^{ₐ}. Let [symbol] (w) be the sum of those h functions, i.e.,

$$\text{?} ( w ) = {\sum }_{i = 1}^{h} {g}_{i} ( w )$$

then [symbol] (w) is an affine function.

By way of another proof, let h∈, h>1 be the number of affine, vector-valued functions gᵢ that are considered with [symbol] being their sum as defined in Lemma 1. A constructive proof showing that [symbol] is an affine function can include:

$$\begin{matrix}\text{?} ( w ) = {\sum }_{i = 1}^{h} {g}_{i} ( w ) \\ = {\sum }_{i = 1}^{h} ( {C}_{i} w + {d}_{i} ) \\ = {\sum }_{i = 1}^{h} ( {C}_{i} w ) + {\sum }_{i = 1}^{h} {d}_{i} \\ = {\underbrace{( {\sum }_{i = 1}^{h} {c}_{i} )}}_{\tilde{C}} w + {\underbrace{{\sum }_{i = 1}^{h} {d}_{i}}}_{\tilde{d}} \\ = \tilde{C} w + \tilde{d}\end{matrix}$$

where \tilde{C}∈ [symbol] ⁿ^{ₐ}^{×n}^{_{b}} and \tilde{d}∈ [symbol] ⁿ^{ₐ}, which is again an affine function.

Theorem 2 then shows that if the kernel is normalized for both z=0 and z=1, the parameterized kernel P derived from those conditions can also be normalized for any z∈[0,1]. For any linearly parameterized kernel P(z)∈ [symbol] ^{k×k} it holds that if:

$${\sum }_{i = 1}^{k} {\sum }_{j = 1}^{k} ( P ( 0 ) [ i , j ] ) = 1$$

$$and$$

$${\sum }_{i = 1}^{k} {\sum }_{j = 1}^{k} ( P ( 1 ) [ i , j ] ) = 1$$

$$this implies that$$

$${\sum }_{i = 1}^{k} {\sum }_{j = 1}^{k} ( P ( z ) [ i , j ] ) = 1 ∀ z ∈ [ 0 , 1 ]$$

By way of still another proof, given a parameterized kernel P(z)∈ [symbol] ^{k×k}, the sum function can be defined as [symbol] ₚ(z) as:

$${\text{?}}_{P} ( z ) ) = {\sum }_{i = 1}^{k} {\sum }_{j = 1}^{k} ( P ( z ) [ i , j ] )$$

As specified in Theorem 2, it can be assumed that [symbol] ₚ(0)= [symbol] ₚ(1)=1 is given. From Lemma 1, it is known that [symbol] ₚ(z) is an affine function. It can be shown that

$${\text{?}}_{P} ( 0 ) = {\text{?}}_{P} ( 1 ) = 1 ⇒ {\text{?}}_{P} ( z ) = 1 ∀ z ∈ [ 0 , 1 ]$$

by contradiction. Assume there is a z′∈[0,1] for which it holds that [symbol] ₚ(z′)=r where r∈ [symbol] , r>1. There must then be at least one subinterval vᵢ⊆[0, z′] on which [symbol] ₚ(z) is strictly increasing, i.e.,

$$\frac{d}{d z} {\text{?}}_{P} ( z ) ) > 0.$$

Similarly, there must be at least one subinterval vᵣ⊆[z′, 1] on which [symbol] ₚ(z) is strictly decreasing, i.e.,

$$\frac{d}{d z} {\text{?}}_{P} ( z ) < 0 .$$

However, an affine function ƒ(z)=mz+b has a constant derivative because

$$\frac{d}{dz} f ( z ) = m ,$$

which is independent of z. This implies that [symbol] ₚ(z) is not an affine function. There can hence be no z′ for which [symbol] ₚ(z′)>1. A similar argument can be made for r<1, the proposition follows from these two arguments.

Akin to the derivations described above, parameterized kernels can be derived for box blur and sharpen perturbations as well as motion blur perturbations with other blur angles. The derivations can be done for kernels of arbitrary uneven sizes, but to visualize the results in a concise manner examples for small kernel sizes such as s=3 are shown.

Turning to parameterized kernels for common perturbations, and in a first instance generalized camera shake kernels, tests can also be run for motion blur angles of 0, 90, and 135 degrees. The definition of the center entry can be the same for all of these angles. For 135°, the values on the main diagonal become

$$\frac{1}{s} z$$

with the respective other entries still being 0. For 0°, those in the column crossing through the center and for 90°, those in the row crossing through the center become

$$\frac{1}{s} z$$

with the respective other entries being zero.

The derivation shown and described above can easily be generalized to kernels of arbitrary sizes s∈ [symbol] , s≥3, where s is an uneven number. In those cases, the following can be obtained:

$${p}_{c e n t e r} ( z ) = ( \frac{1}{s} - 1 ) z + 1$$

$${p}_{antidiagonal} ( z ) = \frac{1}{s} z$$

$${p}_{off - antidiagonal} ( z ) = 0$$

In a second instance, box blur kernels may be among the simplest kernels. The two initial conditions for a box blur kernel of size s=3 can be presented as:

$${P}_{z = 0} = ( \begin{matrix}0 & 0 & 0 \\ 0 & 1 & 0 \\ 0 & 0 & 0\end{matrix} ) , {P}_{z = 1} = ( \begin{matrix}\frac{1}{9} & \frac{1}{9} & \frac{1}{9} \\ \frac{1}{9} & \frac{1}{9} & \frac{1}{9} \\ \frac{1}{9} & \frac{1}{9} & \frac{1}{9}\end{matrix} )$$

For the center entry, the following can include:

$$p ( 0 ) = 1 = a \cdot 0 + b \qquad ( 8 )$$

$$p ( 1 ) = \frac{1}{{s}^{2}} = a \cdot 1 + b \qquad ( 9 )$$

From Equation 8, b=1 can be obtained, and using this in Equation 9 yields

$$\frac{1}{{s}^{2}} = a \cdot 1 + 1 ,$$

which implies

$$p ( z ) = ( \frac{1}{{s}^{2}} - 1 ) z + 1 .$$

For non-center entries, the following can be known:

$$p ( 0 ) = 0 = a \cdot 0 + b \qquad ( 10 )$$

$$p ( 1 ) = \frac{1}{{s}^{2}} = a \cdot 1 + b \qquad ( 11 )$$

Equation 10 implies b=0. Using this, it follows from Equation 11 that

$$a = \frac{1}{{s}^{2}} .$$

In summary,

$$p ( z ) = \frac{1}{{s}^{2}} z$$

can be obtained for the non-center entries.

Accordingly, for box blur parameterization, the following is given:

$${p}_{c e n t e r} ( z ) = ( \frac{1}{{s}^{2}} - 1 ) z + 1$$

$${p}_{n o n - center} ( z ) = \frac{1}{{s}^{2}} z$$

In a third instance, for sharpen kernels, initial conditions for a sharpen kernel can include:

$${P}_{z = 0} = ( \begin{matrix}0 & 0 & 0 \\ 0 & 1 & 0 \\ 0 & 0 & 0\end{matrix} ) = {P}_{z = 1} = ( \begin{matrix}0 & - \frac{1}{4} & 0 \\ - \frac{1}{4} & 2 & - \frac{1}{4} \\ 0 & - \frac{1}{4} & 0\end{matrix} )$$

The entry at the center of the kernel can be referred to as the center entry. Given a kernel size s and a row index

$$j ∈ [ 1 , \frac{s - 1}{2} ] ,$$

the first

$$\frac{s - 1}{2} - j$$

and the last

$$\frac{s - 1}{2} - j$$

entries in the row can be referred to as zero entries. For row indices

$$j ∈ [ \frac{s + 1}{2} , s ]$$

and the first

$$j - \frac{s + 1}{2}$$

and the last

$$j - \frac{s + 1}{2}$$

entries in the row can be referred to as zero entries. All entries that are neither center nor zero entries can be referred to as negative entries. To make these definitions easier to understand, the types of entries can be visualized for a 5×5 kernel with e_{c}, e_{z}, eₙ denoting center, zero, and negative entries, respectively:

$$( \begin{matrix}{e}_{z} & {e}_{z} & {e}_{n} & {e}_{z} & {e}_{z} \\ {e}_{z} & {e}_{n} & {e}_{n} & {e}_{n} & {e}_{z} \\ {e}_{n} & {e}_{n} & {e}_{c} & {e}_{n} & {e}_{n} \\ {e}_{z} & {e}_{n} & {e}_{n} & {e}_{n} & {e}_{z} \\ {e}_{z} & {e}_{z} & {e}_{n} & {e}_{z} & {e}_{z}\end{matrix} ) ( \begin{matrix}{e}_{z} & {e}_{z} & {e}_{n} & {e}_{z} & {e}_{z} \\ {e}_{z} & {e}_{n} & {e}_{n} & {e}_{n} & {e}_{z} \\ {e}_{n} & {e}_{n} & {e}_{c} & {e}_{n} & {e}_{n} \\ {e}_{z} & {e}_{n} & {e}_{n} & {e}_{n} & {e}_{z} \\ {e}_{z} & {e}_{z} & {e}_{n} & {e}_{z} & {e}_{z}\end{matrix} )$$

For the sake of simplicity, the kernels can be generalized to larger kernel sizes by assuming that all negative entries in the kernel have the same value. The following affine parameterizations for the kernel entries can then be calculated.

For the sharpen case, it holds for the center entry that:

$$p ( 0 ) = 1 = a \cdot 0 + b \qquad ( 12 )$$

$$p ( 1 ) = 2 = a \cdot 1 + b \qquad ( 13 )$$

b=1 immediately follows from the Equation 12 and Equation 13 then implies that a=1 to arrive at p(z)=z+1.

For zero entries, it is known that p(0)=p(1)=0 and therefore p(z)=0.

For negative entries, at least because each negative entry should have the same value and the sum of all elements in the kernel should be one, it can be important to know how many negative entries there are in a kernel of size s×s. To determine this, the number of zero entries in one of the four corners of the kernel can be counted. For the top-left corner in the 5×5 kernel for example, there are two zero entries in the first row and one in the second row. In general, there are always

$$\frac{s - 1}{2}$$

zeros in the first row,

$$\frac{s - 1}{2} - 1$$

zeros in the second row, and so on until one zero entry is reached in the

$$\frac{s - 1}{2} - th$$

row. Each corner, therefore, can have

$$\frac{1}{2} \frac{s - 1}{2} ( \frac{s - 1}{2} + 1 )$$

zero entries and because there are four such corners, there are

$$2 \frac{s - 1}{2} ( \frac{s - 1}{2} + 1 ) \text{=:} {q}_{z}$$

zero entries in total. The number of negative entries is hence the total number of entries minus the one center entry and the number of zero entries, i.e., s²−q_{z}−1=:qₙ. This can result in:

$$p ( 0 ) = 0 = a \cdot 0 + b \qquad ( 14 )$$

$$p ( 1 ) = - \frac{1}{{q}_{n}} = a \cdot 1 + b \qquad ( 15 )$$

Equation 14 implies b=0 and from Equation 15 it follows that

$$b = - \frac{1}{{q}_{n}} ,$$

hence

$$p ( z ) = - \frac{1}{{q}_{n}} z .$$

Accordingly, for sharpen parameterization, the following can be obtained:

$${p}_{c e n t e r} ( z ) = z + 1$$

$${p}_{z e r o} ( z ) = 0$$

$${p}_{n e g a t i v e} ( z ) = - \frac{1}{{q}_{n}} z$$

Derivations for even kernel sizes are also provided. As mentioned before, experiments for even kernel sizes can be omitted due, at least in part, to the fact that the identity kernel is not well-defined for such kernel sizes. An example of an approximation for an evenly sized identity kernel, here in the s=4 case, can be given as:

$$( \begin{matrix}0 & 0 & 0 & 0 \\ 0 & \frac{1}{4} & \frac{1}{4} & 0 \\ 0 & \frac{1}{4} & \frac{1}{4} & 0 \\ 0 & 0 & 0 & 0\end{matrix} )$$

Convolving an input image with this kernel can introduce a slight blurring effect at least because it is effectively a 2×2 box blur kernel. For high-resolution images, the use of evenly-sized kernels might still be possible at least because the effect is less visible there, but for low-resolution images it is most likely infeasible. Parameterizations can be shown for some evenly-sized kernels of size s×s here, and they can be derived using the disclosed technology. In those kernels, the entries at positions

$$( \frac{s}{2} , \frac{s}{2} ) , ( \frac{s}{2} , \frac{s}{2} + 1 ) , ( \frac{s}{2} + 1 , \frac{s}{2} ) , and ( \frac{s}{2} + 1 , \frac{s}{2} + 1 )$$

can be referred to as center entries.

For camera shake with an angle φ∈{0°, φ∈90°} and for a kernel size of 4 and a motion blur angle of 0 degrees, the initial conditions can include:

$${P}_{z = 0} = ( \begin{matrix}0 & 0 & 0 & 0 \\ 0 & \frac{1}{4} & \frac{1}{4} & 0 \\ 0 & \frac{1}{4} & \frac{1}{4} & 0 \\ 0 & 0 & 0 & 0\end{matrix} ) , {P}_{z = 1} = ( \begin{matrix}0 & \frac{1}{8} & \frac{1}{8} & 0 \\ 0 & \frac{1}{8} & \frac{1}{8} & 0 \\ 0 & \frac{1}{8} & \frac{1}{8} & 0 \\ 0 & \frac{1}{8} & \frac{1}{8} & 0\end{matrix} )$$

At least because there is no true center row/column to model motion blur, the two rows/columns that are closest to the true center can be used. For arbitrary even filter sizes, the following can be derived:

$${p}_{center} ( z ) = ( \frac{1}{2 s} - \frac{1}{4} ) z + \frac{1}{4}$$

$${p}_{non - center} ( z ) = \frac{1}{2 s} z$$

For camera shake with an angle φ∈{45°, ¢ € 135°}, the initial conditions for a kernel size of 4 and an angle of φ=45° can be:

$${P}_{z = 0} = ( \begin{matrix}0 & 0 & 0 & 0 \\ 0 & \frac{1}{4} & \frac{1}{4} & 0 \\ 0 & \frac{1}{4} & \frac{1}{4} & 0 \\ 0 & 0 & 0 & 0\end{matrix} ) , {P}_{z = 1} = ( \begin{matrix}0 & 0 & 0 & \frac{1}{4} \\ 0 & 0 & \frac{1}{4} & 0 \\ 0 & \frac{1}{4} & 0 & 0 \\ \frac{1}{4} & 0 & 0 & 0\end{matrix} )$$

$${P}_{z = 0} = ( \begin{matrix}0 & 0 & 0 & 0 \\ 0 & \frac{1}{4} & \frac{1}{4} & 0 \\ 0 & \frac{1}{4} & \frac{1}{4} & 0 \\ 0 & 0 & 0 & 0\end{matrix} ) , {P}_{z = 1} = ( \begin{matrix}0 & 0 & 0 & \frac{1}{4} \\ 0 & 0 & \frac{1}{4} & 0 \\ 0 & \frac{1}{4} & 0 & 0 \\ \frac{1}{4} & 0 & 0 & 0\end{matrix} )$$

Unlike the 0° and 90° motion blur trails, the 45° and 135° trails are well-defined in the case of even kernel sizes. This means that the parameterisation is different for center entries that lie on the antidiagonal in the 45° case/main diagonal in the 135° case and those center entries that do not. The center entries on the respective diagonal can be referred to as on-center, marked in green in the above example (top right and bottom left of the four boxes above), and those center entries that do not lie on the diagonal as can be referred to as off-center, marked in orange in the above example (top left and bottom right of the four boxes above). The following parameterization can be derived:

$${p}_{center} ( z ) = ( \frac{1}{s} - \frac{1}{4} ) z + \frac{1}{4}$$

$${p}_{off - center} ( z ) = - \frac{1}{4} z + \frac{1}{4}$$

$${p}_{non - center} ( z ) = \frac{1}{s} z$$

For box blur, the initial conditions for a 4×4 box blur kernel can include:

$${P}_{z = 0} = ( \begin{matrix}0 & 0 & 0 & 0 \\ 0 & \frac{1}{4} & \frac{1}{4} & 0 \\ 0 & \frac{1}{4} & \frac{1}{4} & 0 \\ 0 & 0 & 0 & 0\end{matrix} ) , {P}_{z = 1} = ( \begin{matrix}\frac{1}{16} & \frac{1}{16} & \frac{1}{16} & \frac{1}{16} \\ \frac{1}{16} & \frac{1}{16} & \frac{1}{16} & \frac{1}{16} \\ \frac{1}{16} & \frac{1}{16} & \frac{1}{16} & \frac{1}{16} \\ \frac{1}{16} & \frac{1}{16} & \frac{1}{16} & \frac{1}{16}\end{matrix} )$$

Therefore, the following can be obtained:

$${p}_{center} ( z ) = ( \frac{1}{{s}^{2}} - \frac{1}{4} ) z + \frac{1}{4}$$

$${p}_{non - center} ( z ) = \frac{1}{{s}^{2}} z$$

For sharpen kernels, the following initial conditions for a 4×4 example can exist:

$${P}_{z = 0} = ( \begin{matrix}0 & 0 & 0 & 0 \\ 0 & \frac{1}{4} & \frac{1}{4} & 0 \\ 0 & \frac{1}{4} & \frac{1}{4} & 0 \\ 0 & 0 & 0 & 0\end{matrix} )$$

$${P}_{z = 1} = ( \begin{matrix}0 & - \frac{1}{8} & - \frac{1}{8} & 0 \\ - \frac{1}{8} & \frac{1}{2} & \frac{1}{2} & - \frac{1}{8} \\ - \frac{1}{8} & \frac{1}{2} & \frac{1}{2} & - \frac{1}{8} \\ 0 & - \frac{1}{8} & - \frac{1}{8} & 0\end{matrix} )$$

There can be four center entries e_{c}. For a kernel size s and an index

$$j ∈ [ 1 , \frac{s}{2} - 1 ] ,$$

the first

$$\frac{s}{2} - 1 - j$$

and last

$$\frac{s}{2} - 1 - j$$

entries in a row can be referred to as zero entries e_{z}. For

$$j ∈ \frac{s}{2} + 1 , s ] ,$$

the first

$$j - \frac{s}{2} - 1$$

and the last

$$j - \frac{s}{2} - 1$$

entries can be referred to as zero entries e_{z}. All other entries can be referred to as negative entries eₙ. In the case of a 6×6 kernel the classification of the entries can be as follows:

$$( \begin{matrix}{e}_{z} & {e}_{z} & {e}_{n} & {e}_{n} & {e}_{z} & {e}_{z} \\ {e}_{z} & {e}_{n} & {e}_{n} & {e}_{n} & {e}_{n} & {e}_{z} \\ {e}_{n} & {e}_{n} & {e}_{c} & {e}_{c} & {e}_{n} & {e}_{n} \\ {e}_{n} & {e}_{n} & {e}_{c} & {e}_{c} & {e}_{n} & {e}_{n} \\ {e}_{z} & {e}_{n} & {e}_{n} & {e}_{n} & {e}_{n} & {e}_{z} \\ {e}_{z} & {e}_{z} & {e}_{n} & {e}_{n} & {e}_{z} & {e}_{z}\end{matrix} ) ( \begin{matrix}{e}_{z} & {e}_{z} & {e}_{n} & {e}_{n} & {e}_{z} & {e}_{z} \\ {e}_{z} & {e}_{n} & {e}_{n} & {e}_{n} & {e}_{n} & {e}_{z} \\ {e}_{n} & {e}_{n} & {e}_{c} & {e}_{c} & {e}_{n} & {e}_{n} \\ {e}_{n} & {e}_{n} & {e}_{c} & {e}_{c} & {e}_{n} & {e}_{n} \\ {e}_{z} & {e}_{n} & {e}_{n} & {e}_{n} & {e}_{n} & {e}_{z} \\ {e}_{z} & {e}_{z} & {e}_{n} & {e}_{n} & {e}_{z} & {e}_{z}\end{matrix} )$$

The number of zero fields in this case can be

$$\frac{1}{2} ( \frac{s}{2} - 1 ) ( \frac{s}{2} - 1 + 1 )$$

per corner, and therefore their total number, can be

$${q}_{z} = 2 ( \frac{s}{2} - 1 ) ( \frac{s}{2} ) .$$

The number of negative fields can therefore be qₙ=s²−q_{z}−4. The following can be derived:

$${p}_{center} ( z ) = \frac{1}{4} z + \frac{1}{4}$$

$${p}_{negative} = - \frac{1}{{q}_{n}} z$$

$${p}_{z e r o} ( z ) = 0$$

FIG. 9B is yet another example table 950 of results from using the disclosed technology. More specifically, the table 950 shows experimental evaluation of the disclosed techniques on resnet34. Each query in this illustrative example can be run with a timeout of 1800 seconds. s can be a filter size and v/us/to can be used to denote a number of verified/unsafe/timeout instances, respectively. As shown, networks retained a high verified robustness against sharpen perturbations. While blurring often can induce an information loss making it challenging to restore original information of an image, sharpening emphasizes an image's texture and can strengthen edges in the image. This robustness to large sharpen perturbation strengths can be observed. Robustness of the network to camera shake perturbations can also be highly dependent on a perturbation angle, especially for a kernel size of 9. While the networks may be vulnerable to camera shake along a 45° and 135° axis, the networks may be more robust to blurring along a 0° axis. Motion blurring along a 90° axis can also affect the networks to a least degree with verified accuracies still being high for strong perturbations, even for a kernel size of 9 and a perturbation strength of 1.0.

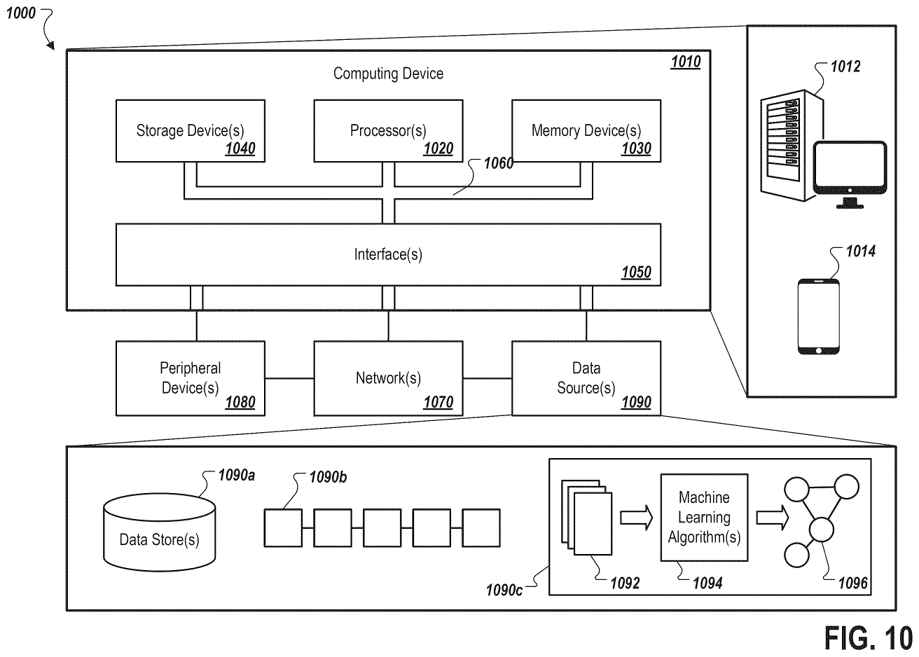

FIG. 10 is a schematic diagram that shows an example of a computing system 1000 that can be used to implement the techniques described herein. The computing system 1000 includes one or more computing devices (e.g., computing device 1010), which can be in wired and/or wireless communication with various peripheral device(s) 1080, data source(s) 1090, and/or other computing devices (e.g., over network(s) 1070). The computing device 1010 can represent various forms of stationary computers 1012 (e.g., workstations, kiosks, servers, mainframes, edge computing devices, quantum computers, etc.) and mobile computers 1014 (e.g., laptops, tablets, mobile phones, personal digital assistants, wearable devices, etc.). In some implementations, the computing device 1010 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1010, and an entire system can be made up of multiple devices communicating with each other. For example, the computing device 1010 can be part of a computing system that includes a network of computing devices, such as a cloud-based computing system, a computing system in an internal network, or a computing system in another sort of shared network. Processors of the computing device (1010) and other computing devices of a computing system can be optimized for different types of operations, secure computing tasks, etc. The components shown herein, and their functions, are meant to be examples, and are not meant to limit implementations of the technology described and/or claimed in this document.

The computing device 1010 includes processor(s) 1020, memory device(s) 1030, storage device(s) 1040, and interface(s) 1050. Each of the processor(s) 1020, the memory device(s) 1030, the storage device(s) 1040, and the interface(s) 1050 are interconnected using a system bus 1060. The processor(s) 1020 are capable of processing instructions for execution within the computing device 1010, and can include one or more single-threaded and/or multi-threaded processors. The processor(s) 1020 are capable of processing instructions stored in the memory device(s) 1030 and/or on the storage device(s) 1040. The memory device(s) 1030 can store data within the computing device 1010, and can include one or more computer-readable media, volatile memory units, and/or non-volatile memory units. The storage device(s) 1040 can provide mass storage for the computing device 1010, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1050 can include various communications interfaces (e.g., USB, Near-Field Communication (NFC), Bluetooth, WiFi, Ethernet, wireless Ethernet, etc.) that can be coupled to the network(s) 1070, peripheral device(s) 1080, and/or data source(s) 1090 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1050 can include a control interface that receives commands from an input device (e.g., operated by a user) and converts the commands for submission to the processors 1020. The interface(s) 1050 can include a display interface that includes circuitry for driving a display to present visual information to a user. The interface(s) 1050 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1070 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1010 can communicate with the peripheral device(s) 1080, the data source(s) 1090, and/or other computing devices over the network(s) 1070. In some implementations, the computing device 1010 can directly communicate with the peripheral device(s) 1080, the data source(s), and/or other computing devices.

The peripheral device(s) 1080 can provide input/output operations for the computing device 1010. Input devices (e.g., keyboards, pointing devices, touchscreens, microphones, cameras, scanners, sensors, etc.) can provide input to the computing device 1010 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1010 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1090 can provide data for use by the computing device 1010, and/or can maintain data that has been generated by the computing device 1010 and/or other devices (e.g., data collected from sensor devices, data aggregated from various different data repositories, etc.). In some implementations, one or more data sources can be hosted by the computing device 1010 (e.g., using the storage device(s) 1040). In some implementations, one or more data sources can be hosted by a different computing device. Data can be provided by the data source(s) 1090 in response to a request for data from the computing device 1010 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1090a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1090b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1090c. The machine learning system(s) 1090c, for example, can be used to analyze data from various sources (e.g., data provided by the computing device 1010, data from the data store(s) 1090a, data from the blockchain(s) 1090b, and/or data from other data sources), to identify patterns in the data, and to draw inferences from the data patterns. In general, training data 1092 can be provided to one or more machine learning algorithms 1094, and the machine learning algorithm(s) can generate a machine learning model 1096. Execution of the machine learning algorithm(s) can be performed by the computing device 1010, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. For example, in at least some embodiments, one or more of the actions disclosed in the flowchart of FIG. 2 can be modified, skipped over, removed, and/or replaced without departing from the spirit of the present disclosure. The inclusion of all the disclosed actions does not require that all such actions must be performed, and thus it is contemplated that claims directed to any subset of the actions disclosed can be performed in a claimed method or by a claimed system. Particular embodiments of the subject matter have been described. Other embodiments are within the scope of the following claims.

1. A system for verifying a user model against convolutional perturbations, the system comprising:
a computing system comprising processors and memory configured to store instructions that, when executed by the processors, causes the processors to perform a process comprising:
receiving user input comprising a user model;
constructing perturbation kernels based on the user input;
deriving parameterized versions of the perturbation kernels as one or more matrices;
precomputing results of convolving input data for the user model with the one or more matrices;
prepending a threshold number of layers to the user model based on the precomputed results;
performing a robustness verification analysis of the user model with the prepended threshold number of layers;
determining whether the user model with the prepended threshold number of layers is robust according to a perturbation specification; and
based on a determination that the user model with the prepended threshold number of layers is robust according to the perturbation specification, returning output indicating robustness of the user model.

2. The system of claim 1, wherein the user model comprises a neural network.

3. (canceled)

4. The system of claim 1, wherein the user input further comprises at least one of (i) the input data for the model or (ii) the perturbation specification.

5. (canceled)

6. (canceled)

7. The system of claim 1, wherein the one or more matrices comprise coefficient matrices and a bias matrix.

8. The system of claim 1, wherein the process further comprises, based on a determination that the user model with the prepended threshold number of layers is not robust according to the perturbation specification:
extracting counterexamples from the robustness verification analysis; and
returning the counterexamples.

9. The system of claim 8, the process further comprising generating and returning one or more recommendations for modifying the user model based on the counterexamples.

10. The system of claim 8, the process further comprising retraining the user model based on the counterexamples.

11. The system of claim 1, wherein the user model comprises a model architecture and model parameters.

12. The system of claim 1, wherein the perturbation specification comprises one or more of perturbation kernels of interest, parameters for the perturbation kernels, or a maximum perturbation strength.

13. The system of claim 12, wherein (i) the perturbation kernels of interest comprise at least one of box blur kernels, sharpen kernels, or motion blur kernels and (ii) the parameters for the perturbation kernels comprise at least one of a size of the perturbation kernels or an angle of a motion blue kernel.

14. (canceled)

15. (canceled)

16. A method for verifying a user model against convolutional perturbations, the method comprising:
receiving user input comprising a user model;
constructing perturbation kernels based on the user input;
deriving parameterized versions of the perturbation kernels as one or more matrices;
precomputing results of convolving input data for the user model with the one or more matrices;
prepending a threshold number of layers to the user model based on the precomputed results;
performing a robustness verification analysis of the user model with the prepended threshold number of layers;
determining whether the user model with the prepended threshold number of layers is robust according to a perturbation specification; and
based on a determination that the user model with the prepended threshold number of layers is robust according to the perturbation specification, returning output indicating robustness of the user model.

17. (canceled)

18. (canceled)

19. The method of claim 16, wherein the input data comprises images.

20. The method of claim 16, wherein the one or more matrices comprise coefficient matrices and a bias matrix.

21. The method of claim 16, wherein based on a determination that the user model with the prepended threshold number of layers is not robust according to the perturbation specification, the method further comprises:
extracting counterexamples from the robustness verification analysis; and
returning the counterexamples for use in modifying the user model.

22. The method of claim 21, further comprising generating and returning one or more recommendations for modifying the user model based on the counterexamples.

23. The method of claim 21, further comprising retraining the user model based on the counterexamples.

24-27. (canceled)

28. A method for verifying a user model against convolutional perturbations, the method comprising:
receiving user input comprising a user model;
constructing perturbation kernels based on the user input;
providing the user input and the perturbation kernels to a robustness verification pipeline;
receiving, as output from the robustness verification pipeline, results indicating robustness of the user model; and
returning the output.

29. The method of claim 28, wherein the robustness verification pipeline comprises:
deriving parameterized versions of the perturbation kernels as one or more matrices;
precomputing results of convolving input data for the user model with the one or more matrices;
prepending a threshold number of layers to the user model based on the precomputed results;
performing a robustness verification analysis of the user model with the prepended threshold number of layers; and
determining whether the user model with the prepended threshold number of layers is robust according to a perturbation specification.

30. The method of claim 29, wherein based on a determination that the user model with the prepended threshold number of layers is robust according to the perturbation specification, the robustness verification pipeline further comprises returning the output indicating the robustness of the user model.

31. The method of claim 29, wherein based on a determination that the user model with the prepended threshold number of layers is not robust according to the perturbation specification, the robustness verification pipeline further comprises:
extracting counterexamples from the robustness verification analysis; and
returning the counterexamples for use in modifying the user model.
